(19) United States
(12) Patent Application Publication
(10) Pub. No.: US 2002/0111794 A1
(43) Pub. Date: Aug. 15, 2002

(54) Method for processing information

(76) Inventors: Hiroshi Yamamoto, Tokyo (JP); Toshimitsu Ohdaira, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/075,000

(22) Filed: Feb. 13, 2002

(30) Foreign Application Priority Data
Feb. 15, 2001 (JP) 2001-38224

(51) Int. Cl. G10L 11/00; G06F 15/00

(52) U.S. Cl. 704/200

(57) ABSTRACT

A first information processing apparatus extracts information expressing a characteristic of input information, changes the input information to character data, subjects the character data to prescribed processing based on the information expressing a characteristic, and sends the character data subjected to the prescribed processing to a network. A second information processing apparatus receives character data via a network, extracts prescribed information from the character data, changes the character data to other information, and subjects the character data or other information to prescribed processing based on the extracted prescribed information. The communication using the first and second information processing apparatuses is, for example, rich and enjoyable, and accompanied by, for example, emotions. The first and second information processing apparatuses enable smooth communication, without an increase in the amount of information that is mutually exchanged.

### CROSS-REFERENCE TO RELATED APPLICATIONS

This application claims priority from Japanese Patent Application No. 2001-38224 filed on Feb. 15, 2001, the disclosure of which is hereby incorporated by reference herein.

### BACKGROUND OF THE INVENTION

The present invention relates to a method and an apparatus for processing information, whereby conversion is performed, for example, from sound information to character information, or from character information to sound information, or whereby processing is performed of sound information in accordance with information appended to, for example, character information. The present invention further relates to an information transmission system that transmits text information, to an information processing program to be executed on a computer, and to a recording medium in which the information processing program is recorded.

In the past, a text-to-speech conversion system existed whereby text information was converted to speech and speech was converted to text information. In this text-to-speech conversion system, text information is converted to speech by, for example, text-speech synthesis processing. This text-speech synthesis processing can be generally divided into language processing and sound processing.

Language processing is processing that converts input text information (for example, a statement formed by kanji and kana characters, in the case of Japanese text) to a phonetic character string expressing information with regard to word pronunciation, accent, and the intonation of the statement. More specifically, in language processing, the pronunciation and accent for each word in an input text is decided using a previously prepared word dictionary, and from the modifying relationship of each clause (the relationship of a modifying passage further modifying a modifying phrase or passage) the intonation of the overall text is established, so as to perform conversion from the text to a string of phonetic characters.

The above-noted sound processing is processing whereby a waveform dictionary previously prepared is used to read the waveforms of each phoneme making up the phonetic character string, so as to build up a speech waveform (speech signal).

In this text-to-speech conversion system, a speech waveform (speech signal) is obtained as a result of converting the text information to speech by means of the above-noted text-speech synthesis processing.

A text-to-speech conversion system performs conversion of speech to text information by means of speech recognition processing, as described below. Speech recognition processing can generally be divided into speech input processing, frequency analysis processing, phoneme recognition processing, word recognition processing, and text recognition processing.

Speech input processing is processing whereby speech is converted to an electrical signal (speech signal) for example, using a microphone or the like.

Frequency analysis processing is processing whereby the speech signal obtained from speech input processing is divided into frames ranging from several milliseconds to several tens of milliseconds, and spectral analysis is performed on each of the frames. This spectral analysis can be performed, for example, by means of a Fast Fourier Transformation (FFT). After noise is removed from the spectral components for each of the frames, conversion is done to speech parameters based on the human auditory scale.

Phoneme recognition processing is processing whereby phonemes are obtained from phoneme models derived from jointly referencing speech parameters in a temporal sequence obtained from the above-noted frequency analysis processing and previously prepared phoneme models. That is, phonemes, and consonants in particular, are expressed as time-varying parameters of the speech spectrum. Phoneme recognition processing performs a comparison between phoneme models expressed as a temporal sequence of speech parameters and temporal sequence speech parameters obtained from the frequency analysis processing, and determines phonemes from this comparison. A phoneme model is obtained beforehand by learning from a large number of speech parameters. The learned model is such as a Markov model of the time sequence pattern, this being the so-called hidden Markov model (HMM).

Word recognition processing is processing whereby the phoneme recognition results obtained from phoneme recognition processing and word models are compared and the level of coincidence therebetween is calculated, the word being determined from the model having the highest level of coincidence. The word model that is used in this case is a model that considers such phoneme deformations as the disappearance of a vowel in the middle of a word, the lengthening of a vowel, nasalization and palatization of consonants, and the like. In order to accommodate changes in the timing of utterances of each phoneme, dynamic planning matching is generally used, this adopting the principal of dynamic planning.

Text recognition processing is processing whereby, from the results obtained from word recognition processing, a series of words is selected which coincides with a language model (a model or syntax describing the joining of words with other words).

In this text-to-speech conversion system, text information made up of the above-noted word series by the above-described speech recognition processing is obtained as a result of conversion from speech to text information.

Studies have been done with regard to the application of the above-noted text-to-speech conversion system to an information transmission system via a network. For example, an information transmission system has already been envisioned whereby text information converted from input speech is transmitted via a network. Additionally, an information system has been envisioned in which text information (for example electronic mail or the like) is converted to speech and output.

In the above-noted text-to-speech conversion system, there is a desire for accurate, error-free conversion when converting text information to speech by text-speech synthesis processing, and when converting speech to text information by speech recognition processing.

For this reason, while the speech obtained from the above-noted text-speech synthesis processing is accurate, it is mechanical speech. This speech is not accompanied by emotion in the voice, as would be the case for a human, but rather is often an inhuman voice. In the same manner, the text information obtained by the speech recognition processing, while accurate, is incapable of expressing content representing the emotions of the speaker.

Additionally, considering, for example, a case in which the above-noted text-to-speech conversion system is combined with an information transmission system via a network, it is difficult for the sending side and the receiving side to establish a mutual link of thought that includes emotions. For this reason, there is a danger that unnecessary misunderstandings will occur.

By sending the speech along with the text information converted from the speech it is possible to send the emotion of the sending side to the receiving side (for example, by a file of compressed speech data attached to text data). This is not desirable, however, because it results in a large amount of information being transmitted.

In the case in which text information and compressed speech data are sent to the receiving side, the compressed speech data sent to the receiving side is the speech at the sending side as is, and there are cases in which it is not desirable to give the receiving side this emotion of the sending side directly in a real manner. That is, in order to establish smooth communication between the sending and receiving sides, it is preferred that, rather than relating the emotion of the sending side realistically to the receiving side, the emotion is softened somewhat. As a further step, it can be envisioned that it would be possible to establish even smoother communication if it were possible to relate enjoyable emotional expressions and exaggerated emotional expressions to both sending and receiving sides.

### SUMMARY OF THE INVENTION

Accordingly, it is an object of the present invention, in consideration of the drawbacks in the conventional art noted above, to provide an information processing method, an information processing apparatus, an information transmission system, an information processing program, and a recording medium in which this information processing program is recorded, these forms of the present invention achieving, for example, information exchange that enables rich and enjoyable expression of emotions and, in a case in which information transmission is done, smooth communication is enabled without an increase in the amount of information transmitted.

In order to achieve the above-noted objects, the present invention extracts prescribed information from character data, converts the character data to other information, and subjects the character data or other information to prescribed processing in accordance with the extracted prescribed information.

Because the prescribed information is information that is originally included within the character data, it is not necessary for the information processing apparatus to provide special information for the purpose of performing the prescribed processing.

The present invention extracts information expressing a characteristics of the input information, converts the input information to character data, and subjects the character data to prescribed processing in accordance with the extracted characteristic.

The prescribed processing to which the character data is subjected is performed in accordance with information expressing the characteristic of the input information. After the prescribed processing, the character data is data with the clear addition of information expressing the above-noted characteristic. Thus, there is hardly any increase in the amount of information, even if this information expressing the characteristic is added.

The present invention achieves information exchange enabling the expression of enjoyable emotions, for example, and enables the achievement of smooth communication, without an increase in the amount of information transmitted.

### BRIEF DESCRIPTION OF THE DRAWINGS

FIG. 1 is a block diagram showing the general configuration of an information processing apparatus according to a first embodiment of the present invention;

FIG. 2 is a block diagram showing the general configuration of an information processing apparatus according to a second embodiment of the present invention;

FIG. 3 is a block diagram showing the general configuration of an information processing apparatus according to a third embodiment of the present invention;

FIG. 4 is a block diagram showing the general configuration of an information processing apparatus according to a fourth embodiment of the present invention;

FIG. 5 is a block diagram showing the general configuration of an information processing apparatus according to a fifth embodiment of the present invention;

FIG. 6 is a block diagram showing the general configuration of an information processing apparatus according to a sixth embodiment of the present invention;

FIG. 7 is a block diagram showing the general configuration of an information processing apparatus according to a seventh embodiment of the present invention;

FIG. 8 is a block diagram showing the general configuration of an information processing apparatus according to a eighth embodiment of the present invention;

FIG. 9 is a block diagram showing the general configuration of an information processing apparatus according to a ninth embodiment of the present invention;

FIG. 10 is a block diagram showing the configuration of a personal computer executing an information processing program; and

FIG. 11 is a drawing showing the general configuration of an information transmission system.

### DETAILED DESCRIPTION

Information Processing Apparatus According to the First Embodiment

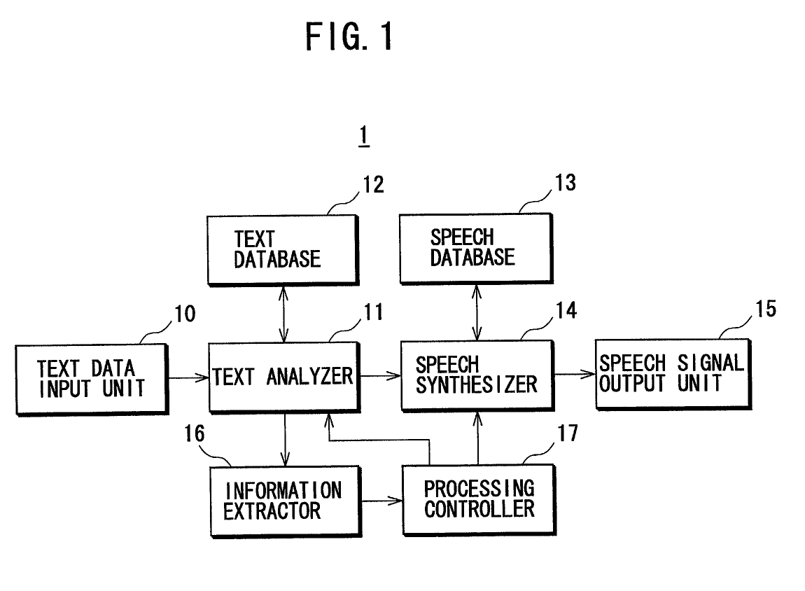

An information processing apparatus according to the first embodiment of the present invention, as shown in FIG. 1, is an apparatus that converts input character data (hereinafter referred to simply as text data) to a speech signal. The configuration shown in FIG. 1 can be implemented with either hardware or software.

In FIG. 1, text data is input to a text data input unit 10. This text data is, for example, data (such as electronic mail or the like) which has been transmitted via a network such as the Internet or an ethernet, data input via a keyboard or the like, or data played back from a recording medium.

A text analyzer 11 uses a word dictionary prepared beforehand in a text database 12 to decide the pronunciation and accent for each word in the input text data, and decide the overall intonation of the text, based on the relative modifying relationships therein, so as to convert the text data into a string of phonetic characters. The text analyzer 11, if necessary, can convert (translate) the input text data to a prescribed language, and can convert the converted (translated) text to the above-noted phonetic character string. The data of the string of phonetic characters obtained by the text processor 11 is sent to a speech synthesizer 14.

The speech synthesizer 14, using a waveform dictionary provided in a speech database 13 beforehand, reads out the waveforms for each phoneme of the phonetic character string so as to build a speech waveform (speech signal).

The speech signal synthesized by the speech synthesizer 14 is output from the speech signal output unit 15 to a later stage (not shown in the drawing). When sound is emanated from the synthesized speech, the synthesized speech signal output from the speech signal output unit 15 is sent to an electrical-to-acoustic conversion means, such as a speaker or the like.

The processing steps performed in the text data input unit 10, text analyzer 11, and speech synthesizer 14 are each similar to the text-speech synthesis processing in the above-described text-to-speech conversion system. It will be understood that the processing to convert text data to a speech signal is not restricted to the processing described above, and can be achieved by using a different method of speech conversion processing.

When generating a phonetic character string in the text analyzer 11, the information processing apparatus 1, based on prescribed information included in the input text data, performs processing of information so as to generate a phonetic character string that encompasses such items as emotion, thinking, gender, facial shape, height, weight, age, occupation, place of birth, hobbies, and preferences. Alternatively, the information processing apparatus 1, when synthesizing speech in the speech synthesizer 14, processes information based on the above-noted prescribed information for the purpose of generating synthesized speech that encompasses the above-noted type of emotion or thinking.

In order to perform information processing based on prescribed information included in the input text data, the information processing apparatus 1 is made up of an information extractor 16 and a processing controller 17.

The information extractor 16 extracts from character codes obtained by analyzing the input text data prescribed character codes and header and footer information, and prescribed phrases and word information within the text data, these being extracted as the above-noted prescribed information. The information extractor 16 then sends the extracted prescribed information to the processing controller 17. It will be understood that the character codes can include control codes, ASCII characters, and, in the case of Japanese-language processing, katakana, kanji, and auxiliary kanji codes.

More specifically, the prescribed information that the information extractor 16 extracts from the input text data includes various codes for text style features, such as character thickness, character size, character color, character type, character position, text style, appearance, notations, punctuation and the like, as well as headers and footers that are appended to the text data, and the words and phrases within the text itself. The information extractor 16 sends this prescribed information to the processing controller 17.

The processing controller 17, based on the prescribed information, performs control of the text analysis in the text analyzer 11, or control of the speech synthesis processing in the speech synthesizer 14. That is, the processing controller 17, based on the above-noted prescribed information, causes the text analyzer 11 to generate a phonetic character string that encompasses, for example, emotion, thinking, gender, facial shape, height, weight, age, occupation, place of birth, hobbies, and preferences. Alternatively, the processing controller 17, based on the above-noted prescribed information, causes the speech synthesizer 14 to generate synthesized speech encompassing the above-noted type of emotion, thinking and the like. The processing controller 17, based on the prescribed information, can perform control of both the speech synthesis processing in the speech synthesizer 14 and the text analysis processing in the text analyzer 11.

The extraction from the text data of the character thickness, or character size or color as prescribed information by the information extractor 16, and the control of the speech synthesis processing in the speech synthesizer 14 by the processing controller 17 based on this prescribed information, are described below by a number of specific examples.

If the prescribed information represents character thickness, the processing controller 17 causes the speech synthesizer 14 to generate synthesized speech that represents a rise in the emotional state or anger of the speaker in response to thick characters. Alternatively, when the prescribed information is, for example, thin characters, the processing controller 17 causes the speech synthesizer 14 to generate synthesized speech representing a drop in the emotional state or sadness in response to the thin characters. Another possibility is the case in which the prescribed information is the large size of the characters, in which case the processing controller 17 causes the speech synthesizer 14 to generate synthesized speech representing an adult in response to the large characters. Yet another possibility is the case in which the prescribed information is the small size of the characters, in which case the processing controller 17 causes the speech synthesizer 14 to generate synthesized speech representing a child in response to the small characters. Still another possibility is the case in which the prescribed information is, for example, blue characters, in which case the processing controller 17 causes the speech synthesizer 14 to generate synthesized speech representing a male in response to the blue characters. Yet another possibility is the case in which the prescribed information is, for example, pink characters, in which case the processing controller 17 causes the speech synthesizer 14 to generate synthesized speech representing a female in response to the pink characters.

The extraction by the information extractor 16 of phrases and words included in the text as prescribed information, and the control by the processing controller 17 of the speech synthesis processing in the speech synthesizer 14 based on this prescribed information, are described below by specific examples.

If the prescribed information is, for example, a phrase with “high volume,” “high emotional level,” or “fast tempo,” the processing controller 17 causes the speech synthesizer 14 to generate synthesized speech representing the raised emotional level or the like of the speaker in accordance with that phrase. Alternatively, if the prescribed information is, for example, a phrase with “low volume,” “low emotional level,” or “slow tempo,” the processing controller 17 causes the speech synthesizer 14 to generate synthesized speech representing the low emotional level or the like of the speaker in accordance with that phrase.

The extraction by the information extractor 16 of punctuation included in the text as prescribed information, and the control by the processing controller 17 of the generation of a phonetic character string in the text analyzer 11 based on this prescribed information, are described below for specific examples, such as those in which an arbitrary word is added, modified, or appended, or those in which an ending word is processed.

Consider an example in which the processing controller 17 performs control so as to process an ending word. If the prescribed information is punctuation, the processing controller 17 causes the text analyzer 11 to generate synthesized speech into which is inserted a phrase representing a dog or a cat, such as having the sound “nyaa” or “wan” (these being, respectively, representations in the Japanese language of the sounds made by a cat or a dog). In this case, if the phrase is, for example, “that's right,” the text analyzer 11 outputs phonetic character strings “that's right nyaa” or “that's right wan.”

Next, consider an example in which the processing controller 17 performs control so as to add a word after other arbitrary words. If the prescribed information is punctuation, the processing controller 17 causes the text analyzer 11 to insert immediately after a phrase before the internal punctuation an utterance such as “uh” used midway in a sentence to indicate that the speaker is thinking. In this case, if the original words are, for example, a formal sentence such as “With regard to tomorrow's meeting, because of various circumstances, I would like to postpone it,” the text analyzer 11 outputs a phonetic character string for the modified sentence “With regard to tomorrow's meeting, uh, because of various circumstances, uh, I would like to postpone it.”

As another example in which words are added to other arbitrary words, consider the case in which the prescribed information is internal punctuation, and the processing controller 17 causes the text analyzer 11 to insert words after the phrase and immediately before the punctuation representing complaints, such as “you're damned right,” “oh, great!” and “what's gotten into you!” In the same manner, another example is the case in which, when the prescribed information is internal punctuation, the processing controller 17 causes the text analyzer 11 to insert words after the phrase and immediately before the punctuation representing enjoyment, such as “hee, hee” or “ha, ha” and the like.

Additionally, the processing controller 17 can perform control so that the text analyzer 11 is caused to modify a word. For example, the processing controller 17 can cause the text analyzer 11 to change a word in the input text to an arbitrary dialect, or to a different language entirely (that is, to perform translation). One example is the case in which the processing controller 17 causes the text analyzer 11, for example, to convert the expression “sou desu ne” (standard Japanese for “that's right” or “yes” or “that's correct”) to a phonetic character string representing the expression “sou dennen” (meaning the same, but in the dialect of the Kansai area of Japan), or causing the text analyzer 11 to convert “konnichi wa” (“good day” or “hello” in Japanese) to a phonetic character string representing other corresponding non-Japanese language expressions, such as “Hello,” “Guten Tag,” “Nihao,” or “Bon jour.”

It will be understood that the examples of the prescribed information and the control of the text analyzer 11 and the speech synthesizer 14 described above are merely exemplary, and that the present invention is not to be restricted to these examples, the combination of the type of prescribed information and the control to be performed being arbitrarily settable by the system.

As described above, the information processing apparatus 1 can, in response to character codes, a header, and/or a footer of text data, or to prescribed information of phrases or words, control the text analyzer 11 and/or the speech synthesizer 14 so that when performing text analysis processing or speech synthesis processing, information processing is performed so as to consider such items as emotion, thinking, gender, facial shape, height, weight, age, occupation, place of birth, hobbies, and preferences. Because the prescribed information is part of the text data itself, such as character codes, words, and phrases, the information processing apparatus 1 need not handle specially provided information to control information processing, nor does it require special software or the like.

Text that has been subjected to information processing such as described above can, for example, be displayed as is on a screen of a monitor apparatus or the like. By displaying the processed text data on a display screen, it is possible for a person with a hearing disability, for example, to recognize the content of the information after processing.

Information Processing Apparatus According to the Second Embodiment

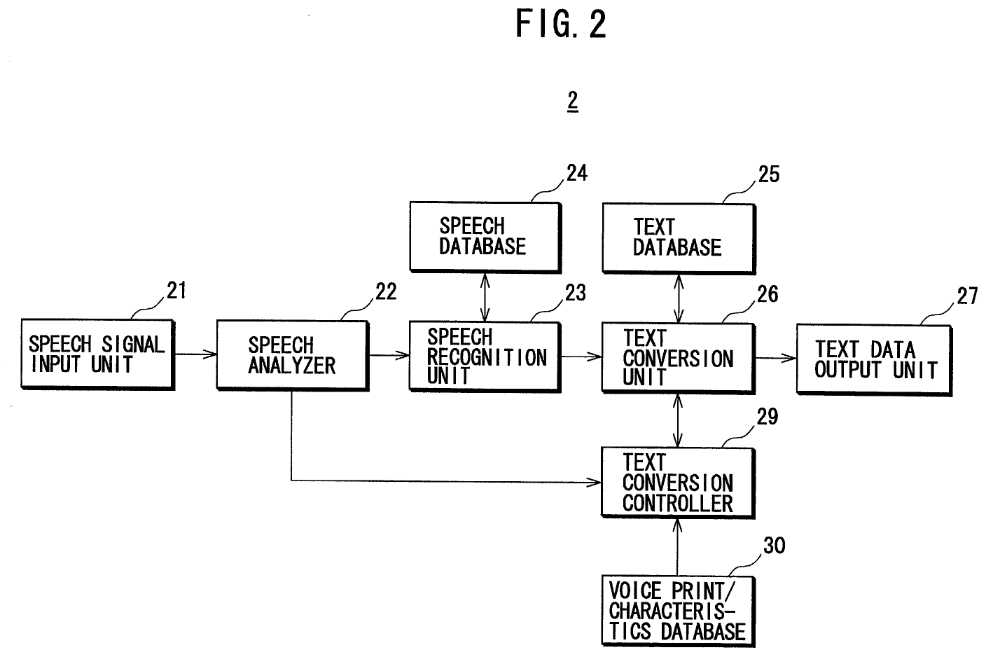

An information processing apparatus 2 as shown in FIG. 2 is an information processing apparatus which converts an input speech signal to text data. The configuration shown in FIG. 2 can be implemented with either hardware or software.

In FIG. 2, a speech signal is input to a speech signal input unit 21. This speech signal is a signal obtained using an acousto-electrical conversion element, such as a microphone or the like, a speech signal transmitted via a communication circuit, or a speech signal or the like played back from a recording medium. This input speech signal is sent to a speech analyzer 22.

The speech analyzer 22 performs level analysis of the speech signal sent from the speech signal input unit 21, divides the speech signal into frames from several milliseconds to several tens of milliseconds, and further performs spectral analysis on each of the frames, for example, by means of a Fast Fourier Transform. The speech analyzer 22 removes noise from the result of the spectral analysis, after which it converts the result to speech parameters in accordance with the human auditory scale, and sends the result to a speech recognition unit 23.

The speech recognition unit 23 compares the speech parameters of a time series with phoneme models prepared beforehand in a speech database 24. The speech recognition unit 23 performs speech recognition processing so as to obtain phonemes from the phoneme models obtained from the comparison, and sends the results of this recognition to a text conversion unit 26. The phoneme models in this case are, for example, hidden Markov models (HMM) obtained by learning.

The text conversion unit 26 performs a comparison of the speech recognition results and word models prepared beforehand in a text database 25, and performs word recognition processing so as to determine words from the phoneme models having the highest level of coincidence based on the comparison. The text conversion unit 26 performs a comparison between the word recognition results and a word model prepared beforehand in the text database 25 so as to select a series of coinciding words and generate text data. The word model that is used in this case is a model that considers such phoneme deformations as the disappearance of a vowel in the middle of a word, the lengthening of a vowel, nasalization and palatization of consonants, and the like. The language model is determined as a model for the joining of words with other words, or as the grammar of the language.

The above-noted text data is output from a text data output unit 27 to a later stage (not shown in the drawing) In the case in which the text data is transmitted via a network, the text data output unit 27 includes means for connection to the network. In the case in which the text data is recorded on a recording medium, the text data output unit includes means of recording the text data onto a recording medium.

The various processing performed in the above-described speech signal input unit 21, speech analyzer 22, speech recognition unit 23, and text conversion unit 26 is substantially the same as speech recognition processing performed in the above-described text-to-speech conversion system. It will be understood, however, that the processing to convert a speech signal to text data in the present invention is merely exemplary, and that a different method of speech-text conversion processing can be used.

The information processing apparatus 2 according to the second embodiment controls text conversion processing in the text conversion unit 26 so as to identify a speaker's emotions, thinking, physical condition, gender, facial shape, height, weight, age, occupation, place of birth, hobbies, preferences and the like from the input speech signal and in response to these identification results. The text data after this conversion processing is sent to the information processing apparatus 1 of the first embodiment. By doing this, the information processing apparatus 1, when performing the text analysis (including language conversion such as translation and the like) or speech synthesis described above, performs processing that takes into consideration the emotions, thinking, physical condition, gender, facial shape, height, weight, age, occupation, place of birth, hobbies, preferences and the like of the speaker. It will be understood, of course, that the information processing apparatus 1 can perform the processing even in the case of general text data which has not been subjected to text conversion processing by the information processing apparatus 2 of the second embodiment.

The information processing apparatus 2 is configured so as to control the text conversion processing based on the results of identifying the emotions, thinking, physical condition, gender, facial shape, height, weight, age, occupation, place of birth, hobbies, preferences and the like of the speaker, by encompassing a text conversion controller 29 and a voiceprint/characteristics database 30.

The text conversion controller 29, based on spectral components obtained by speech analysis done by the speech analyzer 22 and text data converted from the speech recognition results by the text conversion unit 26, identifies the emotions, thinking, physical condition, gender, facial shape, height, weight, age, occupation, place of birth, hobbies, preferences, and the like included in the input speech signal. The text conversion controller 29 sends control commands responsive to the identification results to the text conversion unit 26.

That is, the text conversion controller 29, based on so-called voiceprint analysis theory, performs a comparison between spectral components and levels of the input speech signal and characteristic data representing voiceprints prepared beforehand in the voiceprint/characteristics database 30 so as to identify the emotions, the thinking, the shapes of the voice chords and oral and nasal cavities, the bone structure (that is, shape) of the face, the overall body bone structure, height, weight, gender, age, occupation, and place of birth of the speaker, and the physical condition of the speaker based on coughing or sneezing in the case of suffering from a cold. The text conversion controller 29 compares the converted text data from the analysis results of the speech analyzer 22 and the speech recognition results with characteristic data prepared beforehand in the voiceprint/characteristics database 30 so as to identify the occupation, place of birth, hobbies, and preferences of the speaker. Additionally, the text conversion controller 29, based on the identified emotions, thinking, physical condition, gender, facial shape, height, weight, age, occupation, place of birth, hobbies, preferences and the like of the speaker, decides character codes, character codes to be changed, or headers and footers, words, and phrases, to be appended to the text data converted from the speech recognition results by the text conversion unit 26. The text conversion controller 29 then sends control commands to the text conversion unit 26 in accordance with those decisions.

These control commands are, for example, commands for appending or modifying, with respect to the text data converted from the speech recognition results by the text conversion unit 26, the character thickness and character size (font size), the character color, the character type (font face, including kana and kanji characters in the case of the Japanese language, Roman letters, and various symbols) the character position (line and column), the text style (number of characters, number of lines, line spacing, character spacing, margins, and the like), appearance, notations, and punctuation, and commands that append or modify information such as a header, a footer, a word or a phrase.

That is, the information processing apparatus 2 performs text conversion by the control codes so that it is possible to perform processing responsive to the prescribed information extracted from the text data by the information processing apparatus 1.

As a more specific description corresponding to the examples of information processing at the information processing apparatus 1, in the case in which, for example, the information processing apparatus 2 identifies from the input speech signal a heightening of the emotion or anger of the speaker, the information processing apparatus 2 performs conversion so as to make the corresponding text bold, or conversely, if a depression of emotion or sadness of the speaker is identified, the information processing apparatus 2 performs conversion so as to make the corresponding text thin. As another example, if the information processing apparatus 2 identifies from the input speech signal that the speaker is an adult, it would perform conversion to make the font size large, but if it identified the speaker as a child, it would perform conversion to make the font size small. Yet another example would be if the information processing apparatus 2 identified the gender of the speaker as being male, it would perform conversion to make the characters blue, but if it identified the gender of the speaker as being female, it would perform conversion to make the characters pink.

The information processing apparatus 2 inserts into text parenthetical phrases such as (high volume), (heightened emotion), and (fast tempo) in the case in which a heightening of emotion or anger of the speaker is identified from the input speech signal. The information processing apparatus 2 similarly inserts into text parenthetical phrases such as (low volume), (depressed emotion), and (slow tempo) in the case in which a depression of emotion of the speaker is identified from the input speech signal.

Additionally, the information processing apparatus 2 can also insert information in a header or footer which requests, for example, a modification of word endings, appending of words, or changing of words.

It will be understood, of course, that the above-described conversion processing (that is, appending of the prescribed information and the like) of the text data by the information processing apparatus 2 in relationship to the information processing control performed by the information processing apparatus 1 is merely an example, and that the present invention is not restricted to this example, the combination of the type of prescribed information and the control to be performed being arbitrarily settable by the system.

As described above, the information processing apparatus 2 of the second embodiment builds into the text data the emotions, thinking, gender, facial shape, height, weight, age, occupation, place of birth, hobbies, preferences or the like, using general character codes, or a header or footer or the like. Thus, the information processing apparatus 2 does not require new information to be prepared in order to express these emotions or qualities or the like. For this reason, considering the case in which the text data is to be sent via a network, the amount of data transmitted does not become large as it does in the case of compressed speech data. Additionally, the information processing apparatus 2 does not require new information or special software in order to be able to express the above-noted emotions or qualities.

Information Processing Apparatus According to the Third Embodiment

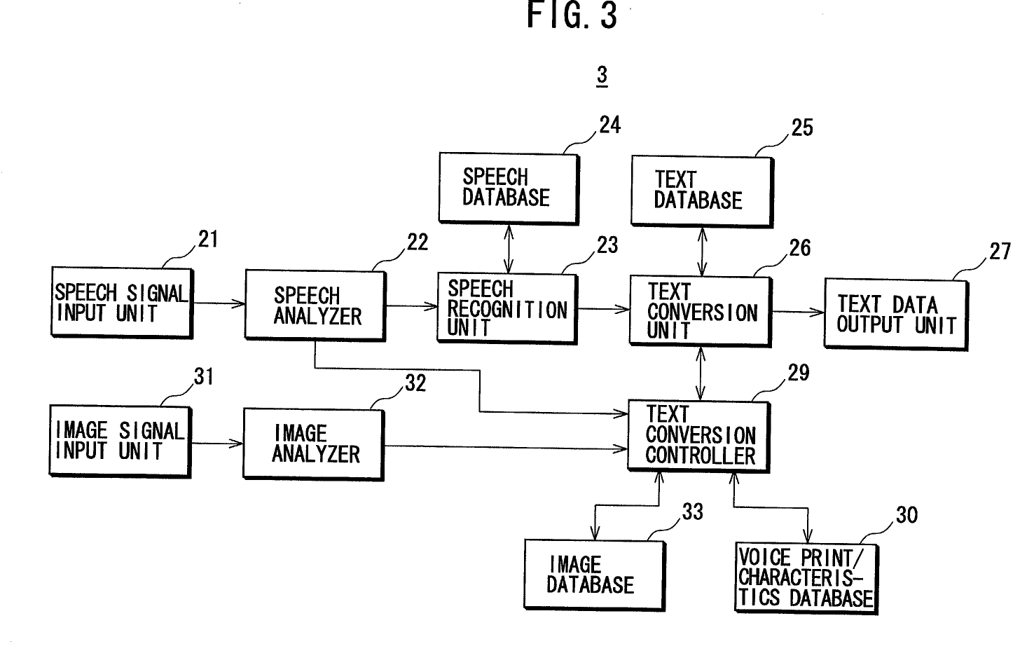

An information processing apparatus 3 as shown in FIG. 3 is an apparatus which, when converting an input speech signal to text, performs text conversion control using an image of the speaker, for example, in addition to the input speech signal. The configuration shown in FIG. 3 can be implemented with either hardware or software. Elements in FIG. 3 that are similar to elements in FIG. 2 are assigned the same reference numerals, and are not described herein.

In the case of this information processing apparatus 3, image signal input unit 31 has input to it an image signal captured from the speaker performing speech input. This image signal is sent to an image analyzer 32.

The image analyzer 32 uses characteristic spatial analysis, for example, which is a method for extracting characteristics from an image, and performs an affine transform, for example, of the face image of the speaker so as to build an expression space of the face and classify the expression on the face. The image analyzer 32 extracts expression parameters of the classified face, and sends the expression parameters to the text conversion controller 29.

The text conversion controller 29, based on spectral components and levels obtained by analysis processing at the speech analyzer 22 and text data converted from speech recognition results by the text conversion unit 26, identifies the emotions, thinking, physical condition, gender, facial shape, height, weight, age, occupation, place of birth, hobbies, and preferences of the speaker, in the same manner as for the information processing apparatus 2, and uses the expression parameters discussed above to perform further identification of the emotions, thinking, gender, physical condition, and facial shape of the speaker. The text conversion controller 29 generates control commands responsive to the identification results. That is, the text conversion controller 29 of the information processing apparatus 3, in addition to performing processing in accordance with the input speech signal, makes a comparison between expression parameters representing various facial expressions previously stored in an image database 33 and expression parameters obtained by the image analyzer 32, this comparison thereby identifying the emotions, thinking, gender, physical condition, and facial shape and the like of the speaker. More specifically, the text conversion controller 29 identifies emotions from such expressions as enjoyment, sadness, surprise, hatred and the like, and identifies gender, physical condition and the like from facial characteristics. The text conversion controller 29 then generates control commands responsive to these identifications, and sends them to the text conversion unit 26. It will be understood that the above-noted text conversion processing and related expressions and the like are merely an example, and that it is possible to have an arbitrary setting thereof in this system, so that the present invention is not restricted to the above-described example.

Thus, because the text conversion controller 29 uses not only the input speech signal but also a facial image of the speaker, it can perform a more accurate identification of the emotions, thinking, physical condition, gender, facial shape, height, weight, age, occupation, place of birth, hobbies, preferences and the like of the speaker.

Information Processing Apparatus According to the Fourth Embodiment

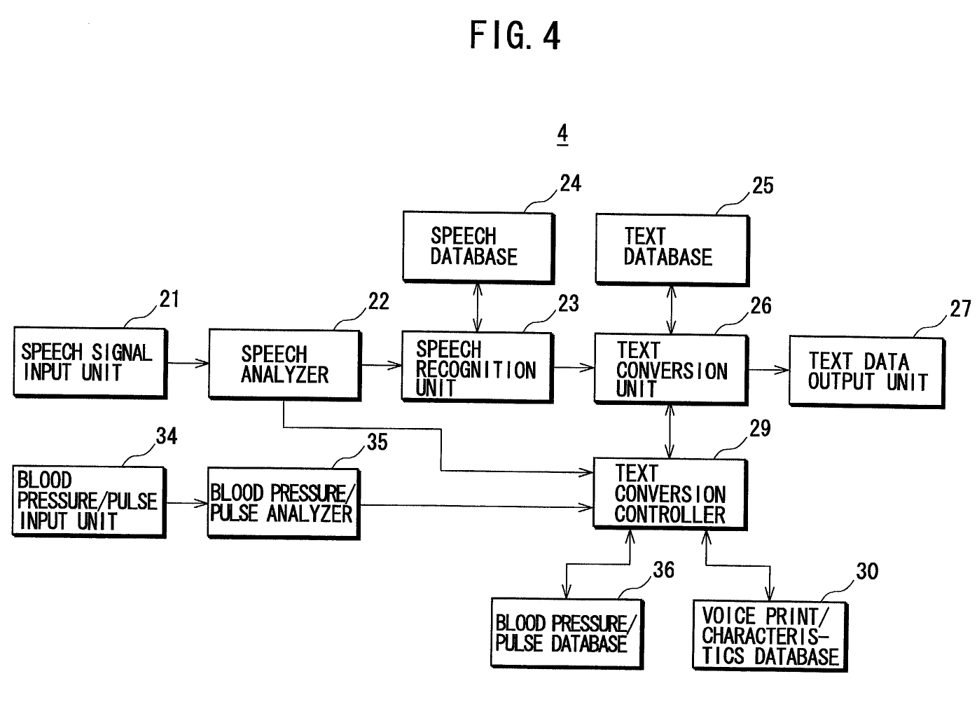

An information processing apparatus 4 as shown in FIG. 4 is an apparatus which, when converting an input speech signal to text, performs text conversion control using the blood pressure and pulse rate of the speaker, for example, in addition to the input speech signal. The configuration shown in FIG. 4 can be implemented with either hardware or software. Elements in FIG. 4 that are similar to elements in FIG. 2 are assigned the same reference numerals, and are not described herein.

A measurement signal from a sphygmomanometer or pulse measurement device attached to the speaker performing speech input is input to a blood pressure/pulse input unit 34 of the information processing apparatus 4. The measurement signal is sent to a blood pressure/pulse analyzer 35. The blood pressure/pulse analyzer 35 analyzes the measurement signal, extracts the blood pressure/pulse parameters representing the blood pressure and pulse of the speaker, and sends these parameters to the text conversion controller 29.

The text conversion controller 29, based on spectral components and levels obtained by analysis processing at the speech analyzer 22 and text data converted from speech recognition results by the text conversion unit 26, identifies the emotions, thinking, physical condition, gender, facial shape, height, weight, age, occupation, place of birth, hobbies, and preferences of the speaker, and uses the blood pressure/pulse parameters to perform further detailed identification. The text conversion controller 29 generates control commands responsive to the identification results. That is, the text conversion controller 29, in addition to performing processing in accordance with the input speech signal, makes a comparison between blood pressure/pulse parameters of various persons previously stored in blood pressure/pulse database 36 and blood pressure/pulse parameters obtained by the blood pressure/pulse analyzer 35, this comparison thereby identifying the emotions, thinking, gender, physical condition, facial shape, height, weight, age, occupation, place of birth, hobbies, preferences and the like of the speaker. More specifically, the text conversion controller 29 identifies emotions of surprise, anger, and fear or the like from a high blood pressure or a fast pulse and identifies emotions of restfulness and the like from a lowblood pressure or slow pulse. The text conversion controller 29 then generates control commands responsive to the results of these identifications, and sends them to the text conversion unit 26. It will be understood that the above-noted text conversion processing and related emotions and the like are merely an example, and that it is possible to have an arbitrary setting thereof in this system, so that the present invention is not restricted to the above-described example.

Thus, because the text conversion controller 29 uses not only the input speech signal but also, for example, measurement signals of the blood pressure/pulse of the speaker, it can perform a more accurate identification of the emotions, thinking, physical condition, gender, facial shape, height, weight, age, occupation, place of birth, hobbies, preferences and the like of the speaker.

Information Processing Apparatus According to the Fifth Embodiment

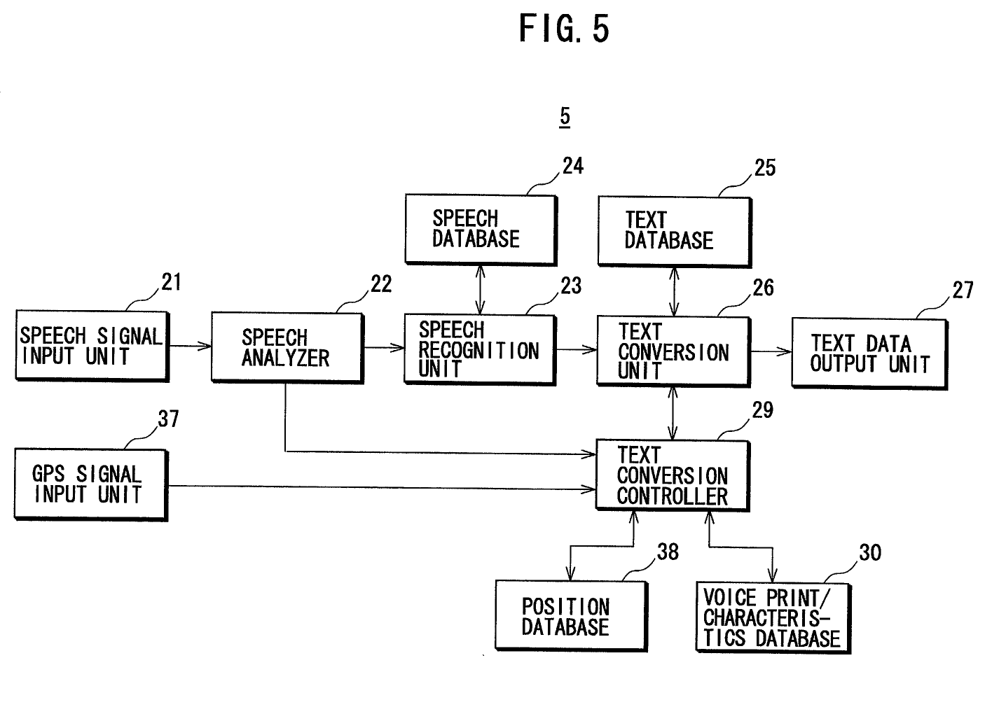

An information processing apparatus 5 as shown in FIG. 5 is an apparatus which, when converting an input speech signal to text, performs text conversion control using current position information of the speaker, for example, in addition to the input speech signal. The configuration shown in FIG. 5 can be implemented with either hardware or software. Elements in FIG. 5 that are similar to elements in FIG. 2 are assigned the same reference numerals, and are not described herein.

Latitude and longitude signals from a GPS (Global Positioning System) position measuring apparatus indicating the current position of the speaker performing speech input are input to a GPS signal input unit 37 of the information processing apparatus 5. These latitude and longitude signals are sent to the text conversion controller 29.

The text conversion controller 29, in addition to identifying the emotions or the like of the speaker based on the input speech signal, identifies the current position of the speaker using the latitude and longitude signals, and generates control commands responsive to this identification data. Thus, the text conversion controller 29, in addition to processing based on the input speech signal, performs a comparison between latitude and longitude information for various locations previously stored in a position database 38 and the latitude and longitude signals obtained from the GPS signal input unit 37, so as to identify the current position of the speaker.

Thus, because the text conversion controller 29 not only uses the input speech signal but also, for example, identifies the current position of the speaker, it is possible to generate effective control commands when a dialect or language conversion is to be made in response to the current position of the speaker.

Information Processing Apparatus According to the Sixth Embodiment

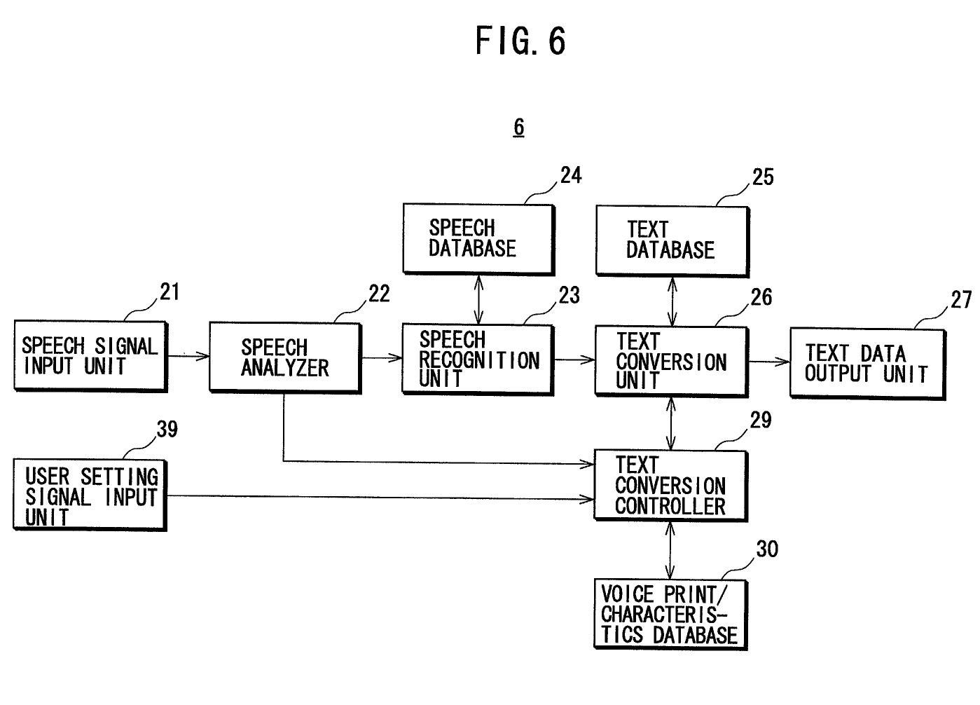

Information processing apparatus 6 as shown in FIG. 6 is an apparatus which, when converting an input speech signal to text, uses various user setting information set by, for example, the speaker, in addition to the input speech signal to generate control commands. The configuration shown in FIG. 6 can be implemented with either hardware or software. Elements in FIG. 6 that are similar to elements in FIG. 2 are assigned the same reference numerals, and are not described herein.

User setting signals input by a user (speaker or the like) by operation of a keyboard, a mouse, or a portable information terminal are supplied to a user setting signal input unit 39 of the information processing apparatus 6. The user setting signals in this case are direct information from the user with regard to the emotions, thinking, physical condition, gender, facial shape, height, weight, age, occupation, place of birth, hobbies, preferences or the like of the speaker. These user setting signals are sent to the text conversion controller 29.

The text conversion controller 29, in addition to identifying the emotions or the like of the speaker based on the input speech signal, makes a more detailed identification using the user setting signals, and generates control commands responsive to these identifications. Thus, the text conversion controller 29, in addition to processing based on the input speech signal, generates control commands responsive to the emotions, physical condition, gender, facial shape, height, weight, age, occupation, place of birth, hobbies, preferences or the like of the speaker as set by the user.

Thus, because the information processing apparatus 6 can input not only a speech signal, but also direct information from a user for making the above-noted identifications, the text conversion controller 29 can make a more accurate and certain identification of the speaker's (user's) emotions and the like than in the case in which an apparatus detects an input speech signal, an image, the blood pressure and pulse, or the latitude and longitude of the speaker and the like. This information used by the information processing apparatus 6 in making identification of the emotions and the like can be directly input by the user. For this reason, the user can freely input information that is completely different from his or her current or true emotions, thinking, physical condition, gender, facial shape, height, weight, age, occupation, place of birth, hobbies, preferences or the like. Accordingly, in contrast to the situation when speech synthesis or language conversion or the like is to be performed based on the text data in the information processing apparatus 1 of FIG. 1, by the user inputting arbitrary information to the information processing apparatus 6, it is possible to perform speech synthesis processing or language conversion processing that is in accordance with the intention of the user.

Information Processing Apparatus According to the Seventh Embodiment

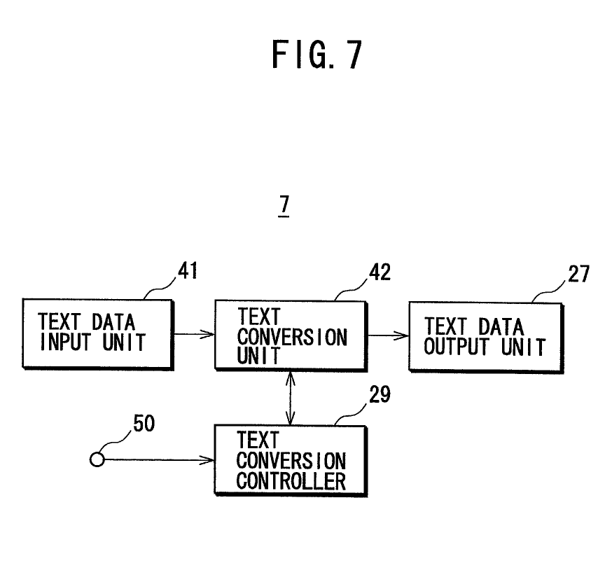

Information processing apparatus 7 as shown in FIG. 7 is an apparatus which performs conversion processing of input text data according to the control commands discussed above. The configuration shown in FIG. 7 can be implemented with either hardware or software. Elements in FIG. 7 that are similar to elements in FIG. 2 are assigned the same reference numerals, and are not described herein.

Text data is input to a text data input unit 41 of the information processing apparatus 7. This text data is, for example, data input from a keyboard or a portable information terminal, data input via a communication circuit, or text data played back from a recording medium. The text data is sent to a text conversion unit 42.

In the same manner as in the cases of the second to sixth embodiments, generated identification results information is input at terminal 50, this information being sent to the text conversion controller 29. The text conversion unit 42, in accordance with control commands from the text conversion controller 29, performs conversion processing on this text data.

Thus, the information processing apparatus 7 can perform conversion processing responsive to the above-noted control commands, on arbitrary text data, such as text data input from a keyboard or portable information terminal, text data input via a communication circuit, and text data played back from a recording medium.

Information Processing Apparatus According to the Eight Embodiment

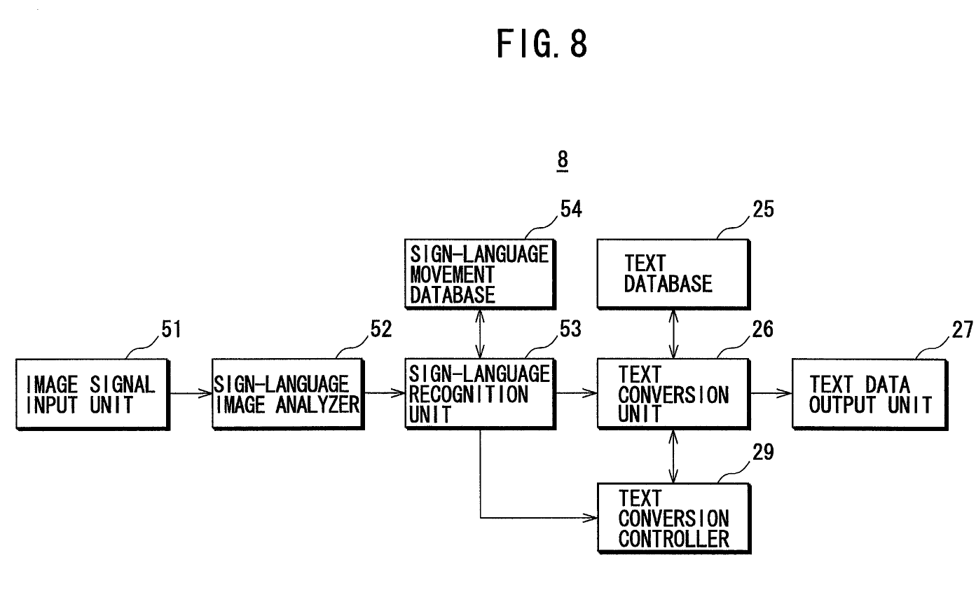

Information processing apparatus 8 as shown in FIG. 8 is an apparatus which converts a sign-language image to text data, and performs conversion processing of the text data according to the above-noted control commands. The configuration shown in FIG. 8 can be implemented with either hardware or software. Elements in FIG. 8 that are similar to elements in FIG. 2 are assigned the same reference numerals, and are not described herein.

A captured moving image of a person speaking in sign language is input to a sign-language image signal input unit 51 of the information processing apparatus 8. This moving image signal is sent to a sign-language image analyzer 52.

The sign-language image analyzer 52 extracts the outline of the person speaking in sign language, and then extracts characteristic points of the body of that person. The sign-language image analyzer 52 detects the hand shape, the starting position and the movement path of the sign language, so as to obtain movement data of the person speaking in sign language. That is, the sign-language image analyzer 52 determines time difference images for frames of, for example, 1/30second, and from these time difference images extracts image parts in which both hands or fingers are moving quickly, and detects the hand shapes made by the hands and fingers and the movement paths of the hand and finger positions, so as to obtain these as movement data which is sent to a sign-language recognition unit 53.

The sign-language recognition unit 53 performs a comparison between the movement data and movement patterns representing the characteristics of sign language prepared beforehand in sign-language movement database 54 for each sign-language, so as to determine sign language words from the movement patterns obtained from this comparison. The sign-language recognition unit 53 then sends these sign-language words to the text conversion unit 26.

The text conversion unit 26 performs a comparison between word models prepared beforehand in a text database 25 and the above-noted sign-language words so as to generate text data.

The text conversion controller 29, based on sign-language words recognized by the sign-language recognition unit 53 and text data converted therefrom by the text conversion unit 26, identifies the emotions, thinking, physical condition, gender, facial shape, height, weight, age, occupation, place of birth, hobbies, preferences and the like of the sign-language speaker, and generates control commands responsive to the results of these identifications.

Thus, the information processing apparatus 8 can perform conversion processing of the text data determined from a sign-language image in accordance with the above-noted control commands.

Information Processing Apparatus According to the Ninth Embodiment

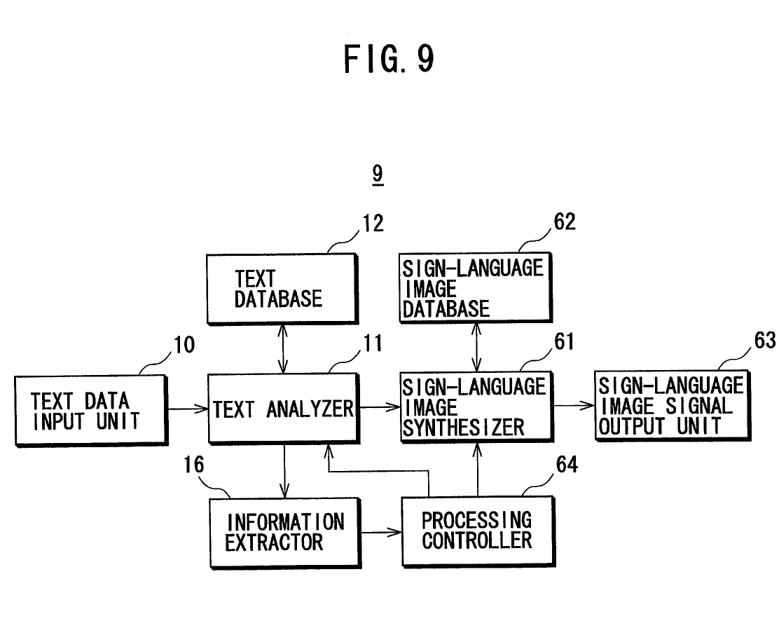

Information processing apparatus 9 as shown in FIG. 9 is an apparatus which generates a sign-language image from text data, and processes the sign-language image in response to the above-noted prescribed information. The configuration shown in FIG. 9 can be implemented with either hardware or software. Elements in FIG. 9 that are similar to elements in FIG. 1 are assigned the same reference numerals, and are not described herein.

In the apparatus shown in FIG. 9, data of a phonetic character string obtained by the text analyzer 11 is sent to a sign-language image synthesizer 61.

The sign-language image synthesizer 61 uses a sign-language image dictionary prepared beforehand in a sign-language image database 62 to read out the sign-language images corresponding to the phonetic character string so as to construct a sign-language image.

A processing controller 64, based on prescribed information supplied from the information extractor 16, performs modification on the sign-language image synthesis processing and text analysis processing so as to generate processing control data, this processing control data being sent to the sign-language image synthesizer 61 and the text analyzer 11.

The sign-language image synthesizer 61 performs processing on the sign-language images, which is substantially the same as the information processing control with respect to the synthesized speech described above. That is, this is achieved in a manner similar to the above-described information processing control with respect to the synthesized speech, but in the form of sign-language images, for example, by performing control of the processing of word endings, and by performing control so as to add words or phrases expressing anger or enjoyment. It will be understood that the processing control data in relation to the sign-language images in this case is merely exemplary, that it is possible for the system to set this arbitrarily, and that the present invention is not restricted to this example.

The sign-language image synthesized by the sign-language image synthesizer 61 is sent from the sign-language image signal output unit 63 to a subsequent monitor apparatus or the like (not shown in the drawing) on which it is displayed. If the sign-language image is transmitted over a network, the sign-language image signal output unit 63 includes means for connection to the network. In the case in which the sign-language image is recorded on a recording medium, the sign-language image signal output unit includes means for recording the image onto a recording medium.

Thus, the information processing apparatus 9 not only generates a sign-language image from text data, but also can perform processing of the sign-language image in response to prescribed information extracted from the text data. By doing this, it is possible for a hearing-impaired person, for example, to recognize the information-processing content.

General Block Configuration of an Information Processing Apparatus

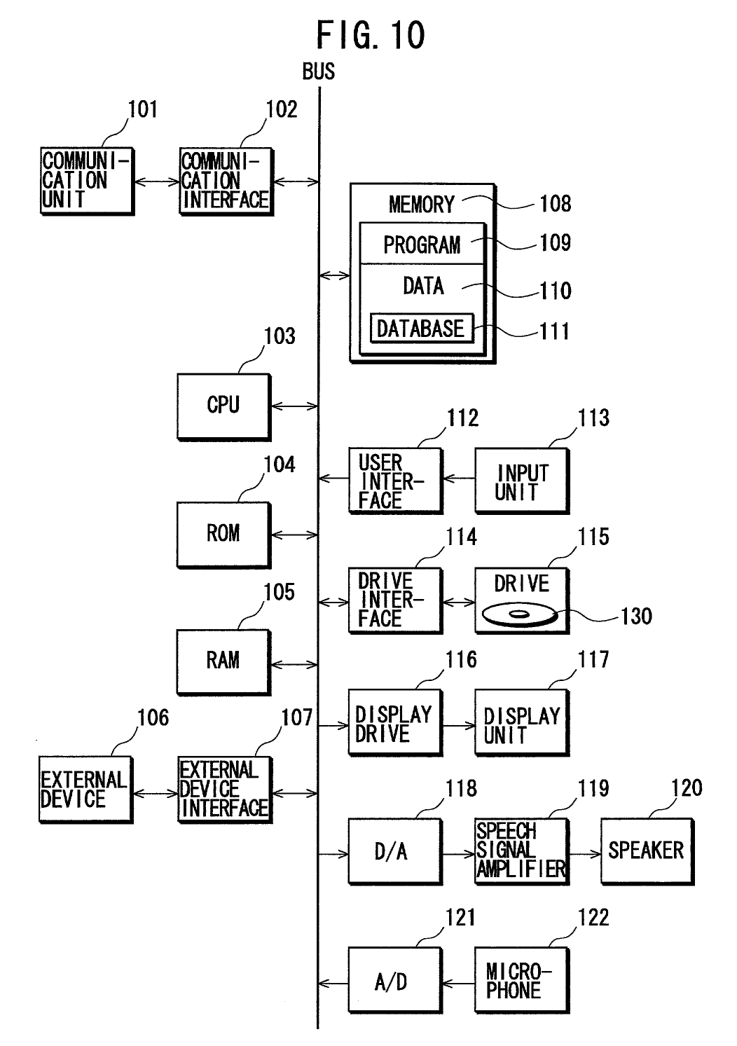

FIG. 10 shows a general block configuration of a personal computer executing an information processing program so as to implement the information processing of any one of the above-described first through ninth embodiments of the present invention. It will be understood that FIG. 10 shows only the main parts of the personal computer.

Referring to FIG. 10, a memory 108 is formed by a hard disk and associated drive. This memory 108 stores not only an operating system program, but also various programs 109 including an information processing program for implementing in software the information processing of one of the first to ninth embodiments. The program 109 includes a program for reading or data read in from a CD-ROM or DVD-ROM or other recording medium, and a program for receiving and sending information via a communication line. The memory 108 has stored in it a database 111 for each of the database parts described for the first to ninth embodiments, and other types of data 110. The information processing program can be installed from a recording medium 130 or downloaded via a communication line. The database can also be acquired from the recording medium 130 or via a communication line, and can be provided together with or separate from the information processing program.

A communication unit 101 is a communication device for performing data communication with the outside. This communication device can be, for example, a modem for connection to an analog subscriber telephone line, a cable modem for connection to a cable TV network, a terminal adaptor for connection to an ISDN (Integrated Service Digital Network), or a modem for connection to an ADSL (Asymmetric Digital Subscriber Line). A communication interface 102 is an interface device for the purpose of performing protocol conversion or the like so as to enable data exchange between the communication unit 101 and an internal bus. The personal computer depicted in FIG. 10 can be connected to the Internet via the communication unit 101 and communication interface 102, and can perform searching, browsing, and sending and receiving of electronic mail and the like. Signals of the text data, image signals, speech signals, and blood pressure and pulse signals can be captured via the communication unit 101.

An external device 106 is a device that handles speech signals or image signals, such as a tape recorder, a digital camera, or a digital video camera or the like. The external device 106 can also be a device that measures blood pressure or pulse signals. Therefore, the above-noted face image signal or sign-language image signal, and blood pressure or pulse measurement signal can be captured from the external device 106. An external device interface 107 internally captures a signal supplied from the external device 106.

An input unit 113 is an input device such as a keyboard, a mouse, or a touch pad. A user interface 112 is an interface device for internally supplying a signal from the input unit 113. The text data discussed above can be input from the input unit 113.

A drive 115 is capable of reading various programs or data from a disk medium 130, such as a CD-ROM, a DVD-ROM, or a floppy disk[TM ], or from a semiconductor memory or the like. A drive interface 114 internally supplies a signal from the drive 115. The text data, image signal, speech signal or the like can also be read from any one of the types of disk media 130 by the drive 115.

A display unit 117 is a display device such as a CRT (Cathode Ray Tube) or liquid crystal display or the like. A display drive 116 drives the display unit 117. The images described above can be displayed on the display unit 117.

A D/A converter 118 converts digital speech data to an analog speech signal. A speech signal amplifier 119 amplifies the analog speech signal, and a speaker 120 converts the analog speech signal to an acoustic wave and outputs it. After synthesis, speech can be output from the speaker 120.

A microphone 122 converts an acoustic wave into an analog speech signal. An A/D converter 121 converts the analog speech signal from the microphone 122 to a digital speech signal. A speech signal can be input from this microphone 122.

A CPU 103 controls the overall operation of the personal computer of FIG. 10 based on an operating system program and the program 109 which are stored in the memory 108.

A ROM 104 is a non-volatile reprogrammable memory, such as a flash memory or the like, into which is stored, for example, the BIOS (Basic I/O System) of the personal computer of FIG. 10, and various initialization setting values. A RAM 105 has loaded into it an application program read out from a hard disk of the memory 108, and is used as the working RAM for the CPU 103.

In the configuration shown in FIG. 10, the CPU 103 executes an information processing program, which is one of the application programs read out from a hard disk of the memory 108 and loaded into the RAM 105, so as to perform the information processing of each of the embodiments described above.

Configuration of an Information Transmission System

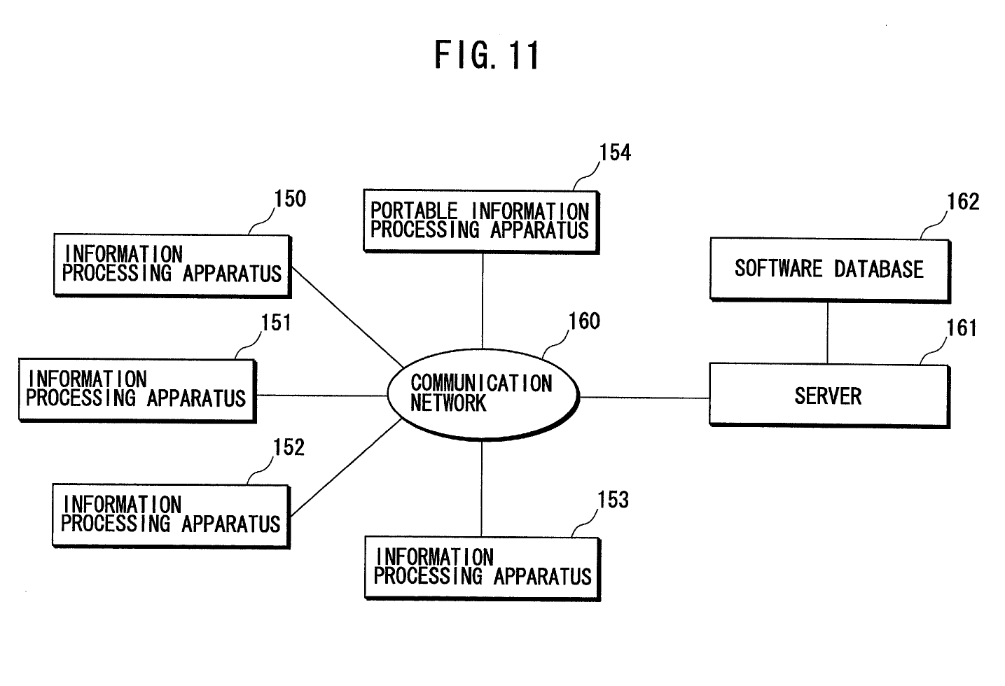

An information transmission system according to the present invention, as shown in FIG. 11, is a system in which information processing apparatuses 150 to 153, which have any one or all of the functions of each embodiment of the present invention, a portable information processing apparatus (portable telephone or the like) 154, and a server 161, which performs information distribution and administration, are connected via a communication network 160, which is the Internet or the like.

In the system depicted in FIG. 11, text data transmitted on the network by any of the information processing apparatuses 150 to 154 is directly, or under the administration of the server 161, transmitted to another of the information processing apparatuses 150 to 154.

Each information processing apparatus receiving the text data performs such processing as processing of a synthesized speech or sign-language image in response to prescribed information extracted from the text data.

The server 161 provides various software, such as information processing programs and databases in a software database 162, and can provide this software in response to a request from each information processing apparatus.

As described above, an information processing apparatus according to each of the embodiments of the present invention enables the achievement of information exchange and modification, enabling rich, enjoyable communication, accompanied by expressions of, for example, emotions, thinking, gender, facial shape, height, weight, age, occupation, place of birth, hobbies, preferences and the like. These information processing apparatuses enable the achievement of a new form of smooth communication, without an increase in the amount of transmitted information. Additionally, the information processing apparatus can provide, for example, a new form of communication even for a person with a hearing disability or a seeing disability.

Additionally, because an information processing system according to the present invention transmits text data, which has a smaller amount of information than images or speech, it is possible to transmit information in real time, even over a low-speed communication line. In the case in which the content of a conversation or sign-language is converted to text data and recorded, because the text data has a small amount of information, it is possible to store text data representing a conversion or sign-language over a long period of time. If text data is recorded, the contents of these conversations or sign-language can be stored in text format as a log. It is possible, therefore, to use a text search to search the contents of conversations or sign-language.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for processing information, comprising:
extracting information expressing a characteristic of speech information;
converting the speech information to character data; and
subjecting the character data to prescribed processing based on the information expressing the characteristic.

2. A method for processing information according to claim 1, wherein
the prescribed processing changes a character form of the character data.

3. A method for processing information according to claim 1, wherein
the prescribed processing changes a control code of the speech information.

4. A method for processing information according to claim 1, wherein
the extracting step extracts information expressing an emotion from the speech information.

5. A method for processing information according to claim 1, further comprising:
sending the character data processed by the prescribed processing to a network.

6. A method for processing information including character data, comprising:
extracting from the character data at least a prescribed character code and one of a prescribed word and a prescribed phrase as prescribed information;
converting the character data to speech information; and
subjecting the character data or speech information to prescribed processing based on the extracted prescribed information,
wherein the prescribed processing performs either processing to add a word expressing an emotion or processing to perform conversion to a word expressing an emotion.

7. An information processing apparatus, comprising:
an information extractor which extracts information expressing a characteristic of speech information;
an information converter which changes the speech information to character data; and
a processor which subjects the character data to prescribed processing based on the information expressing the characteristic.

8. An information transmission system, comprising:
a first information processing apparatus which captures input information, extracts information expressing a characteristic of the input information, changes the input information to character data, subjects the character data to prescribed processing based on the information expressing the characteristic, and sends the character data subjected to the prescribed processing to a network; and
a second information processing apparatus which receives character data via the network, extracts prescribed information from the character data, changes the character data to other information, and subjects the character data or other information to prescribed processing based on the extracted prescribed information.

9. A computer-readable recording medium in which is recorded an information processing program to be executed on a computer, the information processing program comprising:
extracting information expressing a characteristic of speech information;
converting the speech information to character data; and
subjecting the character data to prescribed processing based on the information expressing the characteristic.

10. An information processing program to be executed on a computer, comprising:
extracting information expressing a characteristic of speech information;
converting the speech information to character data; and
subjecting the character data to prescribed processing based on the information expressing the characteristic.
